(19) United States
(12) Patent Application Publication
(10) Pub. No.: US 2007/0019812 A1
(43) Pub. Date: Jan. 25, 2007

(54) Method and apparatus to reproduce wide mono sound

(76) Inventor: Sun-min Kim, Suwon-si (KR)

Correspondence Address: STANZIONE & KIM, LLP, 919 18TH STREET, N.W., SUITE 440, WASHINGTON, DC, 20006, US

(21) Appl. No.: 11/392,750

(22) Filed: Mar. 30, 2006

(30) Foreign Application Priority Data
Jul. 20, 2005 (KR) 2005-65704

(51) Int. Cl. H04R 5/00

(52) U.S. Cl. 381/17

(57) ABSTRACT

A wide mono sound reproducing method and apparatus to widen mono sound by using 2 channel speakers. The method include separating an input mono sound signal into a plurality of decorrelated signals, generating virtual sound sources by localizing each of the separated signals at virtual locations asymmetrical about a center of a front side of a listening point by applying different head related transfer functions to the separated signals, and canceling crosstalk of the generated virtual sound sources.

### CROSS-REFERENCE TO RELATED APPLICATIONS

This application claims the benefit of Korean Patent Application No. 2005-65704, filed on Jul. 20, 2005, in the Korean Intellectual Property Office, the disclosure of which is incorporated herein in its entirety by reference.

### BACKGROUND OF THE INVENTION

1. Field of the Invention

The present general inventive concept relates to an audio reproducing system, and more particularly, to a wide mono sound reproducing method and system to widen mono sound, using 2 channel speakers.

2. Description of the Related Art

Generally, mono sound is reproduced through a single channel, but recently technology for synthesizing virtual stereo sound from mono sound has been under development.

Technology related to a mono sound reproduction system is described in U.S. Patent No. 6,590,983 B1, entitled “Apparatus and method for synthesizing pseudo-stereophonic outputs from a monophonic input.”

FIG. 1 is a block diagram illustrating a conventional mono sound reproducing system. Referring to FIG. 1, a signal M is provided to a left all-pass filter 102 and a right all-pass filter 104. The left all-pass filter 102 is a phase lead filter that generates a leading phase shift of +45 degrees. The right all-pass filter 104 is a phase lead filter that generates a leading phase shift of −45 degrees. The output of the left-all pass filter 102 is provided to a first input of an adder 120 and a non-inverting input of an adder 122. The output of the right all-pass filter 104 is provided to a second input of the adder 120 and an inverting input of the adder 122. The output of the adder 122 is provided to a non-inverting input of an adder 126.

The output of the right all-pass filter 104 is also provided to an input of a perspective filter 124. The output of the perspective filter 124. is provided to an inverting input of the adder 126 and a second input of an adder 128. Also, the output of the left all-pass filter 102 is provided to a non-inverting input of the adder 126 and a third input the adder 128. The output of the adder 128 is provided to a high-pass filter 108 and a first input of an adder 106. The output of the adder 126 is provided to a high-pass filter 110 and a second input of the adder 106. The output of the adder 106 is provided as a low-pass filter 109.

The output of the high-pass filter 108 is provided to a first input of an adder 112, and the output of the low-pass filter 109 is provided to a second input of the adder 112. The output of the adder 112 is provided to an input of a left channel output amplifier 116, and the output of the left channel amplifier 116 is provided to a left channel output.

The output of the high-pass filter 110 is provided to a first input of an adder 114 and the output of the low-pass filter 109 is provided to a second input of the adder 114. The output of the adder 114 is provided to an input of a right channel output amplifier 118, and the output of the right channel amplifier 118 is provided as a right channel output.

Accordingly, the conventional wide mono sound reproduction system as illustrated in FIG. 1 processes a differential signal component generated from left and right input signals in order to generate a stereo sound image. The differential signal is processed by equalization characterized by audible frequency amplification of a low band and high band. The processed differential signal is coupled (i.e., added) with the left and right input signals, and the added signal generated from the original left and right signals.

Accordingly, in the conventional wide mono sound reproduction system, input mono sound is divided into different frequency bands, and levels of the divided bands are corrected and are then recombined. However, since a head and earflap of a listener, which perform important roles in recognizing a direction of a sound source, are not considered at all, performance of the conventional wide mono sound reproduction system is poor. Also, since the conventional wide mono sound reproduction system changes phases when generating two decorrelated signals from the input mono sound, a timbre can be changed.

### SUMMARY OF THE INVENTION

The present general inventive concept provides a wide mono sound reproducing method and system by which input mono sound is divided into a plurality of decorrelated signals and each signal is reproduced through one of a plurality of virtual speakers formed by using different HRTFs.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a wide mono sound reproducing method including separating an input mono sound signal into a plurality of decorrelated signals, generating virtual sound sources by localizing the respective separated signals at virtual locations asymmetrical about a listening point by applying different head related transfer functions to the respective separated signals, and canceling crosstalk of the generated virtual sound sources.

The foregoing and/or other aspects of the present general inventive concept may also be achieved by providing a wide mono sound reproducing method including separating an input mono sound signal into a plurality of decorrelated signals, performing a widening filtering operation by generating virtual sound sources by localizing each of the respective separated signals at virtual locations asymmetrical about a center of a listening point by applying different head related transfer functions to respective separated signals, and canceling crosstalk of the separated signals localized at the virtual locations, and performing a direct filtering operation to adjust signal characteristics between the input mono sound signal and the crosstalk-cancelled virtual sound sources.

The widening filtering operation may be performed according to the following equation:

$$[ \begin{matrix}{W}_{11} & {W}_{12} \\ {W}_{21} & {W}_{22}\end{matrix} ] = [ \begin{matrix}{C}_{11} & {C}_{12} \\ {C}_{21} & {C}_{22}\end{matrix} ] [ \begin{matrix}{B}_{L} ( {θ}_{1} ) + {B}_{R} ( {θ}_{2} ) & {B}_{R} ( {θ}_{1} ) + {B}_{L} ( {θ}_{2} ) \\ {B}_{R} ( {θ}_{1} ) + {B}_{L} ( {θ}_{2} ) & {B}_{L} ( {θ}_{1} ) + {B}_{R} ( {θ}_{2} )\end{matrix} ]$$

where W₁₁, W₁₂, W2₁, and W₂₂ represent widening filter coefficients, C₁₁, C₁₂, C₂₁, and C₂₂ represent crosstalk canceller coefficients, B_{L}(θ₁) and B_{R}(θ₁) respectively represent HRTFs of a left ear and a right ear measured on a right-hand side line making an angle θ₁ from a center of the listening point, and B_{L}(θ₂) and B_{R}(θ₂) respectively represent HRTFs of the left ear and the right ear measured on a right-hand side line making an angle (θ₂) from the center of the listening point.

The foregoing and/or other aspects of the present general inventive concept may also be achieved by providing a wide mono sound reproducing system including a signal separation unit to separate an input mono sound signal into a plurality of decorrelated signals, a binaural synthesis unit to generate virtual sound sources by localizing each of the separated signals at virtual locations asymmetrical about a center of a listening point by applying different head related transfer functions to the respective separated signals, a crosstalk canceller unit to cancel crosstalk between the separated signals of the virtual sound sources localized at the virtual locations by the binaural synthesis unit based on a sound transfer function, a direct filtering unit to adjust signal characteristics between the input mono sound signal and the virtual sound sources crosstalk-cancelled by the crosstalk canceller unit, and an output unit to add a signal output from the direct filtering unit with the signal output from the crosstalk canceller unit and to output the added signals to left and right speakers.

The foregoing and/or other aspects of the present general inventive concept may also be achieved by providing a mono sound system, including an input single channel sound signal, and a virtual sound source generation unit to generate an input single channel sound signal to correspond to at least one of first and second actual speakers, to determine first and second signals from the input single channel sound signal and to generate a plurality of asymmetric virtual speakers to output each of the first and second signals at a wide angle with respect to the listening point of the system.

The foregoing and/or other aspects of the present general inventive concept may also be achieved by providing a single channel sound reproduction system usable in an electronic device, including a virtual sound source generation unit to receive a single channel sound signal as an input, to generate a first plurality of asymmetric virtual sound sources from a first portion of the single channel sound signal, to generate a second plurality of asymmetric virtual sound sources from a second portion of the single channel sound signal, and to combine the first and second asymmetric virtual sound sources with the input single channel sound signal to provide a combined output signal to the at least one actual speaker such that at least one actual speaker outputs the combined output signal.

The foregoing and/or other aspects of the present general inventive concept may also be achieved by providing a sound reproduction system including an input terminal to receive a mono sound signal, a unit to asymmetrically localize first and second components of the mono sound signal, a filter to filter the mono sound signal, and an output terminal to output a combined signal according to the asymmetrically localized first and second components and the filtered mono sound signal.

The foregoing and/or other aspects of the present general inventive concept may also be achieved by providing a method of reproducing a single channel sound usable in an electronic device having at least one actual speaker, including receiving a single channel sound signal to output via the at least one actual speaker, generating a first plurality of asymmetric virtual sound sources from a first portion of the single channel sound signal and generating a second plurality of asymmetric virtual sound sources from a second portion of the single channel sound signal, and combining the first and second asymmetric virtual sound sources with the input single channel sound signal to provide a combined output signal to the at least one actual speaker.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a conventional mono sound reproducing system;

FIG. 2 is a block diagram illustrating a wide mono sound reproducing system according to an embodiment of the present general inventive concept;

FIG. 3 is a conceptual diagram illustrating operation of the wide mono sound reproducing system of FIG. 2 according to an embodiment of the present general inventive concept;

FIGS. 4A and 4B illustrate a signal separation unit of FIG. 2 according to different embodiments of the present general inventive concept;

FIG. 5 is a detailed diagram of the wide mono sound reproducing system of FIG. 2;

FIG. 6 is a simplified block diagram illustrating the wide mono sound reproducing system of FIG. 5 according to an embodiment of the present general inventive concept; and

FIG. 7 is a block diagram illustrating a wide mono sound reproducing system obtained by optimizing the wide mono sound reproducing system of FIG. 6 according to an embodiment of the present general inventive concept.

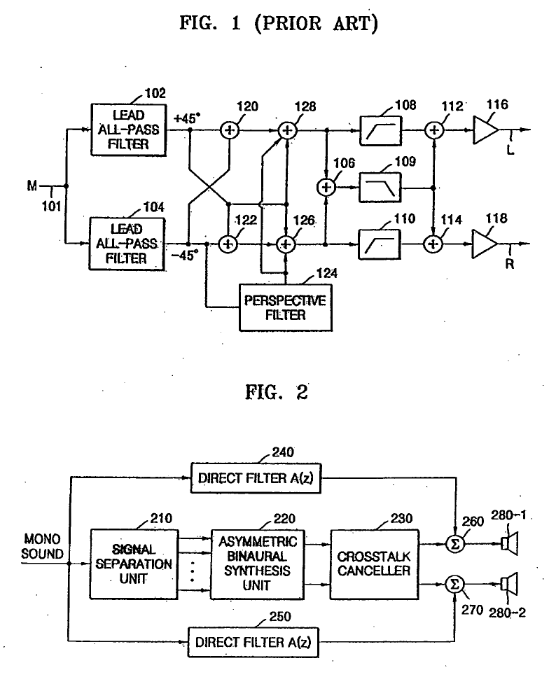

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A wide mono sound reproducing system according to an embodiment of the present general inventive concept, illustrated in FIG. 2, includes a signal separation unit 210, an asymmetric binaural synthesis unit 220, a crosstalk canceller 230, and left and right direct filters 240 and 250.

Referring to FIG. 2, the signal separation unit 210 separates input mono sound into a plurality of decorrelated signals, by dividing the input mono sound with respect to a frequency band or phase. For example, the signal separation unit 210 divides the input mono sound into a low frequency component signal and a high frequency component signal through low-pass filtering and high-pass filtering, respectively.

In order to form virtual sound sources at an arbitrary location, the asymmetric binaural synthesis unit 220 localizes each signal obtained by the signal separation unit 210 asymmetrically about a center of a front side of a listener head (i.e., at a listening point) by applying different head related transfer functions (HRTFs) to the respective signals. That is, the asymmetric binaural synthesis unit 220 arranges virtual speakers using the HRTF, asymmetrically about the center of the front side of the listener head. It should be understood that although the embodiments of the present general inventive concept are described with reference to the listener head, the listener, and the listening point, a listener need not actually be positioned at the listening point. This description is not intended to limit the scope of the present general inventive concept and is included only to demonstrate where a listener's head would typically be positioned when the mono sound reproducing system is being used.

The crosstalk canceller 230 cancels crosstalk between two actual speakers and two ears of the listener, with respect to the virtual sound sources generated in the asymmetric binaural synthesis unit 220. That is, the crosstalk canceller 230 cancels crosstalk of a signal reproduced in the left speaker 280-1 so that the left speaker signal is not heard by the right ear of the listener and cancels crosstalk of a signal reproduced in the right speaker 280-2 so that the right speaker signal is not heard by the left ear of the listener.

The left and right direct filters 240 and 250 are filters of az^{-b}, which have only gain and delay, adjust a signal characteristic between the input mono sound and the virtual sound sources output by the crosstalk canceller 230. Here, ‘a’ represents an output signal level and ‘b’ represents a time delay value that is obtained through an impulse response, phase characteristics, or listening experiments. That is, the left and right direct filters 240 and 250 generate natural sound by adjusting a difference of time delays and output levels between a virtual speaker output associated with the virtual sound source and is an actual speaker output.

Finally, the signals separated from the input mono sound and filtered by the left and right direct filters 240 and 250 and the virtual sound sources output by the crosstalk canceller 230 are combined and output respectively to the left and right speakers 280-1 and 280-2.

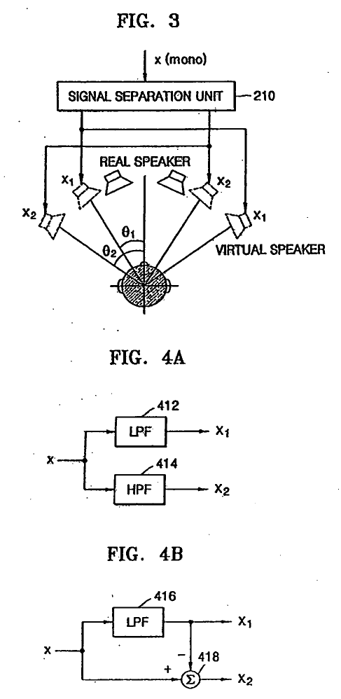

FIG. 3 is a conceptual diagram illustrating operation of the wide mono sound reproducing system of FIG. 2 according to an embodiment of the present general inventive concept.

Referring to FIG. 3, an input mono sound signal (x) is divided into two different signals (x₁, x₂), decorrelated by a signal separation unit 210. The separated signals are reproduced through asymmetrically arranged virtual speakers. The virtual speakers are represented by dotted lines. Four virtual speakers may be formed by reflecting 4 HRTFs measured at different angles (θ₁, θ₂) from the center in front of the listener. Other numbers and/or asymmetrical arrangements of virtual speakers may also be used. That is, the separated signal (x₁) is reproduced through a virtual speaker positioned on a left-hand side line making a first angle (θ₁) with respect to a center line of the listener (i.e., at the listening point), and a virtual speaker positioned on a right-hand side line making a second angle (θ₂) with respect to the center line of the listener, and the separated signal (x₂) is reproduced through a virtual speaker positioned on a left-hand side line making the second angle (θ₂) with respect to the center line of the listener, and a virtual speaker positioned on a right-hand side line making the first angle (θ₁) with respect to the center line of the listener. Accordingly, the virtual speakers are arranged symmetrically from the center of the front side of the listener's head. However, each of the separate signals (x₁, x₂) are input to the virtual speakers asymmetrically about the center of the front side of the listener's head at the listening point.

FIGS. 4A and 4B illustrate the signal separation unit 210 of FIG. 2 according to different embodiments of the present general inventive concept.

Referring to FIG. 4A, the mono sound signal (x) is separated into a low frequency component signal (x₁) and a high frequency component signal (x₂) by an LPF 412 and an HPF 414, respectively.

Referring to FIG. 4B, the mono sound signal (x) is separated into a low frequency component signal (x₁) and a signal (x₂) obtained by adding the original mono sound signal (x) and the low frequency component signal (x₁) through an LPF 416 and an adder 418, respectively. Either one of these embodiments may be used in the wide mono sound reproducing system.

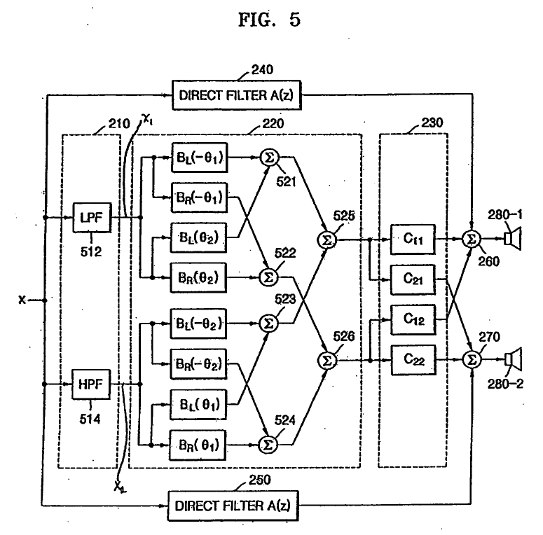

FIG. 5 is a detailed diagram illustrating the wide mono sound reproducing system of FIG. 2 according to an embodiment of the present general inventive concept.

Referring to FIG. 5, the signal separation unit 210 can use an LPF 512 and an HPF 514 to divide an input mono signal sound (x) into bands. Accordingly, the input mono sound signal (x) is divided into two frequency bands by the LPF 512 and HPF 514.

The asymmetric binaural synthesis unit 220 has HRTFs (B_{L}(−θ₁), B_{R}(−θ₁), B_{L}(θ₂), B_{R}(θ₂), B_{R}(−θ₂), B_{L}(−θ₂), B_{L}(θ₁), B_{R}(θ₁)), which are measured from positions on left-hand side and right-hand side lines making different angles with respect to the center line in front of the listener. The asymmetric binaural synthesis unit 220 localizes each signal separated by the signal separation unit 210 at virtual positions asymmetrical about the center of the front side of the listener's head by convolving the separated signals with the HRTFs. Here, B_{L}(−θ₁), and B_{R}(−θ₁) respectively represent an HRTF of the left ear and an HRTF of the right ear measured at a position on a left-hand side line making an angle θ₁ from the front of the listener. Similarly, B_{L}(θ₂), and B_{R}(θ₂) respectively represent an HRTF of the left ear an HRTF of the right ear measured at a position on a right-hand side line making an angle θ₂ from the front of the listener.

B_{R}(−θ₂), and B_{L}(−θ₂) respectively represent an HRTF of the left ear and an HRTF of the right ear measured at a position on a left-hand side line making an angle θ₂ from the front of the listener. B_{L}(θ₁), and B_{R}(θ₁) respectively represent an HRTF of the left ear and an HRTF of the right ear measured at a position on a right-hand side line making an angle θ₁ from the front of the listener. For example, if a sound source signal is convolved with B_{L}(−θ₁) and reproduced through a left channel, and convolved with B_{R}(−θ₁) and reproduced through a right channel, the listener perceives that the virtual sound source is on a line making an angle of −θ from the front of the listening point.

The signal passing. through the LPF 512 is convolved with each of the HRTFs B_{L}(−θ₁), B_{R}(−θ₁), B_{L}(θ₂), and B_{R}(θ₂), and the signal passing through the HPF 514 is convolved with each of the HRTFs B_{R}(−θ₂), B_{L}(−θ₂), B_{L}(θ₁), and B_{R}(θ₁).

The signal convolved with B_{L}(−θ₁) is added to the signal convolved with B_{L}(θ₂) by an adder 521, and the signal convolved with B_{R}(−θ₁) is added to the signal convolved with B_{R}(θ₂) by adder 522. Also, the signal convolved with B_{L}(−θ₂) is added to the signal convolved with B_{L}(θ₁) by an adder 523, and the signal convolved with B_{R}(−θ₂) is added to the signal convolved with B_{R}(θ₁) by an adder 524. The output of the adder 521 and the output of the adder 523 are added by an adder 525 and output to a left channel. The output of the adder 522 and the output of the adder 524 are added by an adder 526 and output to a right channel.

Accordingly, the signal passing through the LPF 512 is reproduced through a virtual speaker positioned on the left-hand side line making the angle θ₁ from the front of the listener, and a virtual speaker positioned on the right-hand side line making the angle θ₂ from the front of the listener, and the signal passing through the HPF 514 is reproduced through a virtual speaker positioned on the left-hand side line making the angle θ₂ from the front of the listener, and a virtual speaker positioned on the right-hand side line making the angle θ, from the front of the listener. Accordingly, the signals passing through the LPF 512 and HPF 514 are localized at virtual positions asymmetrical about the center of the front side of the listener's head (i.e., at the listening point).

The crosstalk canceller 230 digital-filters two channel signals output from the asymmetric binaural synthesis unit 220, through transaural filter coefficients ((C₁₁(Z), C₂₁(Z), C₁₂(Z), C₂₂(Z)) to which a crosstalk cancellation algorithm is applied.

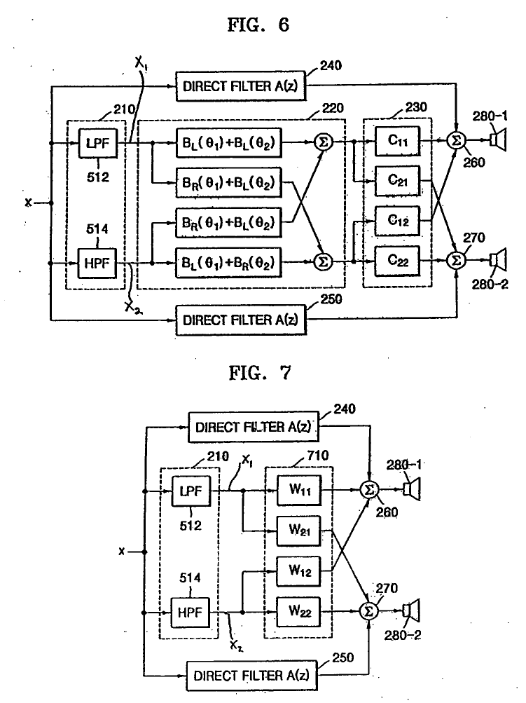

Although the system illustrated in FIG. 5 performs asymmetrical binaural synthesis of separated signals, the virtual speakers as a whole, as illustrated in FIG. 3, have a symmetrical arrangement. In other words, the same number of virtual speakers are output at each side of the listening point at the same positions on each side. Accordingly, if the symmetry of the HRTFs themselves as described below in equation 1 is used, and HRTFs having identical inputs and outputs are added before convolution is performed, the structure can be simplified as illustrated in FIG. 6 according to Equation (1) below.
B_{L}(θ₁)=B_{R}(−θ₁), B_{R}(θ₁)=B_{L}(−θ₁), B_{L}(θ₂)=B_{R}(−θ₂), B_{R}(θ₂)=B_{L}(−θ₂) (1)

As illustrated in FIG. 6, because of the symmetrical arrangement of the virtual speakers, the asymmetric binaural synthesis unit 220 has a symmetrical structure as a whole, and as a result, a sound image can be prevented from leaning to one side. Also, since the two channel signals input to the asymmetric binaural synthesis unit 220 are different signals (x₁) and (x₂) obtained from the mono sound signal that passes respectively through the LPF 512 and the HPF 514, the two signals (x₁) and (x₂) do not generate a phantom image at the center in front of the listener.

Here, since coefficients of the asymmetric binaural synthesis unit 220 and the crosstalk canceller 230 do not change, they can be multiplied by each other to form a widening filter matrix as shown by the following equation (2):

$$[ \begin{matrix}{W}_{11} & {W}_{12} \\ {W}_{21} & {W}_{22}\end{matrix} ] = [ \begin{matrix}{C}_{11} & {C}_{12} \\ {C}_{21} & {C}_{22}\end{matrix} ] [ \begin{matrix}{B}_{L} ( {θ}_{1} ) + {B}_{R} ( {θ}_{2} ) & {B}_{R} ( {θ}_{1} ) + {B}_{L} ( {θ}_{2} ) \\ {B}_{R} ( {θ}_{1} ) + {B}_{L} ( {θ}_{2} ) & {B}_{L} ( {θ}_{1} ) + {B}_{R} ( {θ}_{2} )\end{matrix} ] \qquad ( 2 )$$

where W₁₁, W₁₂, W₂₁, W₂₂ represent widening filter coefficients, C₁₁, C₁₂, C₂₁, C₂₂ represent crosstalk canceller coefficients, B_{L}(θ₁), and B_{R}(θ₁) respectively represent the HRTFs of the left ear and right ear measured on a right-hand side line making an angle θ₁ from the center of the listener, and B_{L}(θ₂) and B_{R}(θ₂) respectively represent the HRTFs of the left ear and right ear measured on a right-hand side line making an angle (θ₂) from the center of the listener.

FIG. 7 is a block diagram illustrating a wide mono sound reproducing system obtained by optimizing the asymmetric binaural synthesis unit 220 and the crosstalk canceller 230 of FIG. 6 using the widening filter matrix.

As illustrated in FIG. 7, by combining the asymmetric binaural synthesis unit 220 and the crosstalk canceller 230, a widening filter unit 710 is defined. If stereo sound passes through the widening filter unit 710 and is reproduced through two speakers, the listener perceives that the sound comes from virtual speakers spaced widely (i.e., a wide angle) in front of the listener (e.g., at θ₁ and/or θ₂). In this case, according to positions and a number of virtual speakers, widened stereo sound is perceived. However, since there may be a feeling of emptiness at the center where no virtual speaker is positioned, the listener may perceive an unstable feeling and the sound may be unnatural with a deteriorated timbre. To solve this problem, sound is also output through the actual left and right speakers 280-1 and 280-2 by defining the left and right direct filters 240 and 250. The left and right direct filters 240 and 250 adjust a magnitude and a time delay of the outputs of the actual speakers (i.e., the left and right speaker 280-1 and 280-2) and the virtual speakers. The time delay of the left and right direct filters 240 and 250 are set to the time delay of the widening filter 710 already designed, in order not to avoid changing the timbre. The left and right direct filters 240 and 250 also determine a ratio of output levels of the actual speakers and the virtual speakers. Accordingly, the left and right direct filters 240 and 250 can adjust a degree to which the stereo sound is separated. In an extreme case, if the magnitudes of the left and right direct filters 240 and 250 are almost 0, sound is reproduced only through the virtual speakers, and therefore the stereo sound stage is widened and there is no sound at the center. Alternatively, if the magnitudes of the left and right direct filters 240 and 250 are very large, sound is reproduced only through the actual speakers (i.e., the left and right speakers 280-1 and 280-2) and the wide stereo effect disappears. Accordingly, the magnitudes of the left and right direct filters 240 and 250 may be determined through listening experiments or sound tests according to a listener preference.

As illustrated in FIG. 7, the widening filter 710 is made to generate the virtual sound sources from the signals input through the two channels and output the sound to the virtual speakers, while the left and right direct filters (A(z)) 240 and 250 are made to adjust signal characteristics between the two channel signals and the virtual sound sources and output the sound to the actual speakers 280-1 and 280-2.

The present general inventive concept can be embodied as computer readable code on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the internet). The computer readable recording medium can also be distributed over network coupled computer systems so that the computer readable code is stored and executed in a distributed fashion.

According to embodiments of the present general inventive concept as described above, when mono sound is reproduced by a device having two speakers with a narrow spacing, for example, a PC, a TV, a notebook PC, or a cellular phone, the stereo sound stage may be widened.

Although the embodiments of the present general inventive concept are described with reference to two real (actual) speakers (e.g., 280-1 and 280-2), it should be understood that some embodiments of the present general inventive concept may be implemented using one real speaker. For example, in an embodiment relating to another sound reproducing system, such as a cellular phone, having a single front center speaker, a plurality of asymmetric virtual speakers can be arranged at a wide angle about the single front speaker.

Accordingly, by widening a sound stage by using an HRTF in relation to an input mono sound, a wider sound stage can be perceived than by the conventional method using a difference signal of the left and right signals.

Also, since a frequency band is divided and different HRTFs are transmitted asymmetrically, a change in timbre is smaller than when using the conventional method which generates left and right signals by changing the phases of the frequency bands.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wide mono sound reproducing method, the method comprising:
separating an input mono sound signal into a plurality of decorrelated signals;
generating virtual sound sources by localizing the respective separated signals at virtual locations asymmetrical about a listening point by applying different head related transfer functions to the respective separated signals; and
canceling crosstalk of the generated virtual sound sources.

2. The method of claim 1, further comprising:
performing a direct-filtering operation to adjust signal characteristics between the input mono sound signal and the crosstalk-cancelled virtual sound sources.

3. The method of claim 2, wherein the performing of the direct-filtering operation comprises determining the signal characteristics according to an output level and a time delay of the crosstalk-cancelled virtual sound sources.

4. The method of claim 1, wherein the separating of the input mono sound signal comprises dividing the input mono sound signal into frequency bands.

5. The method of claim 1, wherein the separating of the input mono sound signal comprises dividing the input mono sound signal into phases.

6. The method of claim 1, wherein the generating of the virtual sound sources comprises:
localizing a separated signal at different virtual locations on a left-hand side and on a right-hand side of the listening point, and
localizing a second separated signal at different virtual locations on the left-hand side and on the right-hand side of the listening point such that the virtual locations of the second separated signal are symmetrical to the virtual locations at which the first separated signal is localized.

7. The method of claim 1, wherein the generating of the virtual sound sources comprises:
reproducing a separated first signal through a virtual speaker positioned on a left-hand side line making a first angle with a center line of the listening point and a virtual speaker positioned on a right-hand side line making a second angle larger than the first angle with the center line of the listening point; and
reproducing a separated second signal through a virtual speaker positioned on a left-hand side line making the second angle with the center line of the listening point and a virtual speaker positioned on a right-hand side line making the first angle with the center line of the listening point.

8. A wide mono sound reproducing method, comprising:
separating an input mono sound signal into a plurality of decorrelated signals;
performing a widening filtering operation by generating virtual sound sources by localizing each of the separated signals at virtual locations asymmetrical about a center of a listening point by applying different head related transfer functions to the respective separated signals, and canceling crosstalk of the separated signals localized at the asymmetrical virtual locations; and
performing a direct filtering operation to adjust signal characteristics between the input mono sound signal and the crosstalk-cancelled virtual sound sources.

9. The method of claim 8, wherein the widening filtering operation is performed by the following equation:
$$[ \begin{matrix}{W}_{11} & {W}_{12} \\ {W}_{21} & {W}_{22}\end{matrix} ] = [ \begin{matrix}{C}_{11} & {C}_{12} \\ {C}_{21} & {C}_{22}\end{matrix} ] [ \begin{matrix}{B}_{L} ( {θ}_{1} ) + {B}_{R} ( {θ}_{2} ) & {B}_{R} ( {θ}_{1} ) + {B}_{L} ( {θ}_{2} ) \\ {B}_{R} ( {θ}_{1} ) + {B}_{L} ( {θ}_{2} ) & {B}_{L} ( {θ}_{1} ) + {B}_{R} ( {θ}_{2} )\end{matrix} ]$$
where W₁₁, W₁₂, W₂₁, W₂₂ represent widening filter coefficients, C₁₁, C₁₂, C₂₁, C₂₂ represent crosstalk canceller coefficients, B_{L}(θ₁), and B_{R}(θ₁) respectively represent first HRTFs of a left ear and a right ear measured on a right-hand side line making an angle θ₁ from a center of the listening point, and B_{L}(θ₂), and B_{R}(θ₂) respectively represent second HRTFs of the left ear and the right ear measured on a right-hand side line making an angle θ₁ from the center of the listening point.

10. The method of claim 8, wherein the widening filtering operation comprises:
applying a first set of predetermined head related transfer functions (HRTFs) to a first one of the plurality of decorrelated signals to localize the first decorrelated signal at two or more asymmetric points with respect to the listening point;
applying a second set of predetermined HRTFs to a second one of the plurality of decorrelated signals to localize the second decorrelated signal at another two or more asymmetric points with respect to the listening point;
adding right ear components output from the applied first set of predetermined HRTFs to right ear components output from the applied second set of predetermined HRTFs to produce a right ear component signal;
adding left ear components output from the applied first set of predetermined HRTFs to left ear components output from the applied second set of predetermined HRTFs to produce a left ear component signal; and
canceling cross talk between the right and left ear component signals using a predetermined matrix of cross talk cancellation coefficients.

11. The method of claim 10, wherein the first set of predetermined HRTFs comprises at least:
first and second HRTFs of left and right ears, respectively, to localize a portion of the first decorrelated signal at a first angle on a first side of the listening point; and
third and fourth HRTFs of the left and right ears, respectively, to localize another portion of the first decorrelated signal at a second angle different from the first angle on a second side of the listening point.

12. The method of claim 8, wherein the widening filtering operation comprises:
applying a predetermined head related transfer function matrix having a plurality of coefficients that correspond to the virtual locations, positions of left and right ears, and characteristics of the left and right ears to localize at least a first one of the plurality of decorrelated signals at a first angle on a first side of the listening point and at a second angle different from the first angle on a second side of the listening point to determine left ear and right ear component signals of the localized first decorrelated signal; and
canceling cross talk between the right and left ear component signals using a predetermined matrix of cross talk cancellation coefficients.

13. A wide mono sound reproducing system comprising:
a signal separation unit to separate an input mono sound signal into a plurality of decorrelated signals;
a binaural synthesis unit to generate virtual sound sources by localizing each of the separated signals at virtual locations asymmetrical about a center of a listening point by applying different head related transfer functions to the respective separated signals;
a crosstalk canceller unit to cancel crosstalk between the separated signals of the virtual sound sources localized at the virtual locations in the binaural synthesis unit based on a sound transfer function;
a direct filtering unit to adjust signal characteristics between the input mono sound signal and the virtual sound sources crosstalk-cancelled by the crosstalk canceller unit; and
an output unit to add a signal output from the direct filtering unit with the virtual sound sources output from the crosstalk canceller unit and to output the added signals to left and right speakers.

14. The system of claim 13, wherein the signal separation unit comprises:
a low-pass filter to filter a low frequency component of the input mono sound signal; and
a high-pass filter to filter a high frequency component of the input mono sound signal.

15. The system of claim 13, wherein an HRTF coefficient matrix of the binaural synthesis unit and a filter coefficient matrix of the crosstalk canceller unit are convolved to form a widening filter coefficient matrix as defined by the following equation:
$$[ \begin{matrix}{W}_{11} & {W}_{12} \\ {W}_{21} & {W}_{22}\end{matrix} ] = [ \begin{matrix}{C}_{11} & {C}_{12} \\ {C}_{21} & {C}_{22}\end{matrix} ] [ \begin{matrix}{B}_{L} ( {θ}_{1} ) + {B}_{R} ( {θ}_{2} ) & {B}_{R} ( {θ}_{1} ) + {B}_{L} ( {θ}_{2} ) \\ {B}_{R} ( {θ}_{1} ) + {B}_{L} ( {θ}_{2} ) & {B}_{L} ( {θ}_{1} ) + {B}_{R} ( {θ}_{2} )\end{matrix} ]$$
where W₁₁, W₁₂, W₂₁, W₂₂ represent widening filter coefficients, C₁₁, C₁₂, C₂₁, C₂₂ represent first crosstalk canceller coefficients, B_{L}(θ₁), and B_{R}(θ₁) respectively represent HRTFs of a left ear and a right ear measured on a right-hand side line making an angle θ₁ from the center of the listener head position, and B_{L}(θ₂), and B_{R}(θ₂) respectively represent second HRTFs of the left ear and the right ear measured on a right-hand side line making an angle (θ₂) from the center of the listener head position.

16. The system of claim 13, wherein the direct filtering unit comprises a filter to provide a gain and a delay to the input mono sound signal.

17. The system of claim 13, wherein the direct filtering unit comprises:
left and right filters to adjust a gain and delay of the input mono sound signal by separating the input mono sound signal into a left signal and a right signal and outputting the left and right signals.

18. A mono sound system, comprising:
a virtual sound source generation unit to generate an input single channel sound signal to correspond to at least one of first and second speakers, to determine first and second signals from the input single channel sound signal and to generate a plurality of asymmetric virtual speakers to output each of the first and second signals at a wide angle with respect to a listening point of the system.

19. The system of claim 18, wherein the plurality of asymmetric virtual speakers comprise:
at least a first and a second virtual speaker to reproduce the first signal on each side of the listening point such that the first and second virtual speakers are positioned at different angles with respect to the listening point of the system; and
at least a third and a fourth virtual speaker to reproduce the second signal on each side of the listening point such that the third and fourth virtual speakers are position at different angles with respect to the listening point of the system.

20. The system of claim 18, wherein the virtual sound source generation unit comprises:
a plurality of head related transfer function units to receive the first and second signals and to generate a plurality of virtual sound source signals on both sides of the first and second actual speakers.

21. The system of claim 20, further comprising:
a cross talk cancellation unit to cancel cross talk among the plurality of virtual sound source signals and to provide the cross talk canceled virtual sound source signals to the first and second actual speakers to be output thereby.

22. The system of claim 20, further comprising:
an adding unit to combine the plurality of virtual sound source signals received from the head related transfer function units with the input single channel sound signal and to provide the combined signals to the first and second actual speakers.

23. The system of claim 22, further comprising:
a direct filter unit to perform an adjustment operation on the input single channel sound signal such that the adjusted input single channel sound signal that is provided to the adding unit has the same phase as the plurality of virtual sound source signals to which the adjusted single channel sound signal is combined.

24. The system of claim 22, further comprising:
a direct filter unit to enable an adjustment operation to be performed on the input single channel sound signal such that a relative magnitude of the input single channel sound signal is adjusted with respect to magnitudes of the virtual sound source signals, and the adjusted single channel sound signal is provided to the adding unit.

25. The system of claim 20, wherein the plurality of head related transfer function units generate left and right virtual sound source signals to be output by the first and second actual speakers, respectively.

26. The system of claim 18, wherein the virtual sound source generation unit comprises a widening unit that divides the input single channel sound signal into the first and second signals, generates the plurality of asymmetric virtual speakers to output for each of the first and second signals at virtual locations, and cancels crosstalk between the virtual speakers at the virtual locations.

27. The system of claim 21, wherein the virtual sound source generation unit comprises a signal separation unit to receive the input single channel sound signal, divides the received single channel sound signal into a low frequency portion and a high frequency portion as the first and second signals, respectively.

28. A single channel sound reproduction system usable in an electronic device, comprising:
a virtual sound source generation unit to receive a single channel sound signal, to generate a first plurality of virtual sound sources asymmetric with respect to a listening point of the electronic device from a first portion of the single channel sound signal, to generate a second plurality of virtual sound sources asymmetric with respect to the listening point of the electronic device from a second portion of the single channel signal, and to combine the first and second asymmetric virtual sound sources with the input single channel sound signal to provide a combined output signal such that at least one actual speaker outputs the combined output signal.

29. The system of claim 28, wherein the first and second pluralities of asymmetric virtual sound sources provide a plurality of virtual speakers that are symmetric with respect to the at least one actual speaker when the combined output signal is output to the at least one actual speaker.

30. The system of claim 28, wherein the electronic device comprises one of a personal computer, a television, a notebook PC, and a cellular phone.

31. The system of claim 28, further comprising:
a direct filtering unit to enable adjustment of relative magnitudes of the first and second pluralities of asymmetric virtual sound sources with respect to the input single channel sound signal.

32. A sound reproduction system comprising:
an input terminal to receive a mono sound signal;
a unit to asymmetrically localize first and second components of the mono sound signal;
a filter to filter the mono sound signal; and
an output terminal to output a combined signal according to the asymmetrically localized first and second components and the filtered mono sound signal.

33. The system of claim 32, wherein the unit comprises:
a signal separation unit to separate the mono sound signal by signal characteristics into first and second decorrelated signals;
an asymmetric binaural synthesis unit to generate a left ear virtual signal component and a right ear virtual signal component from the first and second decorrelated signals at respective asymmetric locations; and
a crosstalk cancellation unit to cancel cross talk between the left and right ear virtual signal components and to provide the crosstalk cancelled left and right ear virtual signal components to the output terminal.

34. The system of claim 33, wherein the asymmetric binaural synthesis unit comprises:
a first head related transfer function (HRTF) unit to apply a first set of predetermined HRTFs to the first decorrelated signal to localize the first decorrelated signal at two or more asymmetric points with respect to a listening point of the system;
a second HRTF unit to apply a second set of predetermined HRTFs to the second decorrelated signal to localize the second decorrelated signal at two or more asymmetric points with respect to the listening point of the system; and
an adding unit to add right ear components output from the first HRTF unit to right ear components output from the second HRTF unit to produce the right ear virtual signal component, to add left ear components output from the first HRTF unit to left ear components output from the second HRTF unit to produce the left ear virtual signal component, and to provide the right and left ear virtual signal components to the crosstalk cancellation unit.

35. The system of claim 32, wherein the filter comprises:
a first filter to adjust signal characteristics of the mono sound signal according to signal characteristics of the asymmetrically localized first component to provide the adjusted mono sound signal to the output terminal to be combined with. the asymmetrically localized first component and output by a first speaker; and
a second filter to adjust signal characteristics of the mono sound signal according to signal characteristics of the asymmetrically localized second component to provide the adjusted mono sound signal to the output terminal to be combined with the asymmetrically localized second component and output by a second speaker.

36. The system of claim 32, wherein the output terminal comprises:
first and second terminals to output the combined signal as a first combined signal to a first speaker and a second combined signal to a second speaker, respectively.

37. The system of claim 32, wherein the asymmetrically localized first and second components of the mono sound signal each include sound information defining a virtual sound source on two sides of a listening point of the system at different relative angles with respect to a center line of the listening point.

38. The system of claim 32, further comprising:
at least one actual speaker to output the combined signal from the output terminal such that first asymmetric virtual speakers are generated for the first component of the mono sound signal and second asymmetric virtual speakers about a listening point in the system such that the first and second components of the mono sound signals are perceived to originate from the first and second asymmetric virtual speakers, respectively, instead of the at least one actual speaker.

39. A method of reproducing a single channel sound usable in an electronic device having at least one actual speaker, comprising:
receiving a single channel sound signal to output via the at least one actual speaker;
generating a first plurality of virtual sound sources asymmetric with respect to a listening point of the electronic device from a first portion of the single channel sound signal and generating a second plurality of virtual sound sources asymmetric with respect to the listening point of the electronic device from a second portion of the single channel sound signal; and
combining the first and second asymmetric virtual sound sources with the input single channel sound signal to provide a combined output signal to the at least one actual speaker.
